(19) United States
(12) Patent Application Publication
(10) Pub. No.: US 2007/0099501 A1
(43) Pub. Date: May 3, 2007

(54) Waterproof connector

(75) Inventors: Shinichi Tsuchiya, Shizuoka (JP); Toshinori Yamamoto, Shizuoka (JP); Yoshimi Wada, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YAZAKI CORPORATION, Tokyo (JP)

(21) Appl. No.: 11/585,090

(22) Filed: Oct. 24, 2006

(30) Foreign Application Priority Data
Oct. 27, 2005 (JP) 2005-313183

(51) Int. Cl. H01R 13/40

(52) U.S. Cl. 439/587

(57) ABSTRACT

The waterproof connector includes: a terminal having an electric wire; a housing body having a terminal insertion opening for inserting the terminal and a terminal receiving chamber for receiving the terminal; a waterproofing means having an electric wire insertion hole that is approximately coaxial with the terminal insertion opening of the housing body; and a rear holder which holds the waterproofing means and has a guide tube for guiding the terminal that is to be inserted into the terminal insertion opening, wherein a tapered part is formed in the proximity of an inlet of the guide tube, the tapered part leading an end part of the terminal inserted in the guide tube to the electric wire insertion hole of the waterproofing means on a condition that the end part of the terminal is inclined.

### BACKGROUND OF THE INVENTION

(1) Field of the Invention

The present invention relates to a waterproof connector for use in electrical connection.

(2) Description of the Related Art

So far, a terminal having a bar-shaped tab has been used as a female connector for use in electrical connection.

FIG. 6 shows a partially enlarged cross sectional view illustrating an intermediate state when a terminal having an electric wire is being inserted into a connector housing of such a conventional female connector.

A female connector α includes a connector housing α1 and a terminal 1′ to be inserted in the connector housing α1.

The connector housing α1 includes a housing body 2′, waterproofing means 4′, and rear holder 3′ as its primary components.

The housing body 2′ has a terminal insertion opening 2a′ to let the terminal 1′ having an electric wire pass therethrough and receives the terminal 1′ having an electric wire inserted through the terminal insertion opening 2a′.

The waterproofing means 4′ is made of a soft material such as an elastomer, e.g. rubber to waterproof the circumference of the electric wire and includes an electric wire insertion hole 4b′ which is approximately coaxial with a center axis of the terminal insertion opening 2a′ of the housing body 2′.

The rear holder 3′ holds the waterproofing means 4′ and has a guide tube 3a′ for guiding the terminal 1′, which is to be inserted into the terminal insertion opening 2a′.

The terminal 1′ includes: a bar-shaped tab 1a′ for connecting the terminal 1′ to a female terminal in a mating connector (not shown in the figure) by being inserted in the female terminal in the mating connector when the female connector α is coupled with the mating connector, the tab 1a′ being situated at an end of the terminal 1′ in an insertion direction of the terminal 1′ into the connector housing α1; an electric wire connecting part 1b′ for connecting the terminal 1′ to the electric wire; and a box part 1c′, wherein a center axis of the tab 1a′ is not aligned with that of the box part 1c′.

The electric wire insertion hole 4b′ of the waterproofing means 4′ is approximately coaxial with the terminal insertion opening 2a′ of the connector housing α1 and an inner diameter of the electric wire insertion hole 4b′ is thinner than an outer diameter of the electric wire. Therefore, when the terminal 1′ passes through the electric wire insertion hole 4b′ , the terminal 1′ presses and extends the electric wire insertion hole 4b′ to pass therethrough.

However, since the center axis of the tab 1a′ of the terminal 1′ having an electric wire is not aligned with that of the box part 1c′, therefore as shown in FIG. 6 first an end of the bar-shaped tab 1a′ of the terminal 1′ abuts against a side surface of an electric wire sealing lip 4a′, which is formed on an inner surface of the electric wire insertion hole 4b′ together with another electric wire sealing lip 4a′, then the terminal 1′ presses and extends the electric wire insertion hole 4b′ so as to pass through the electric wire insertion hole 4b′ rubbing the inner surface of the electric wire insertion hole 4b′.

Due to such a rub, the electric wire insertion hole 4b′ might be damaged, causing insecurity in a waterproof structure formed between the electric wire sealing lip 4a′ and a coating layer of the electric wire.

Thus, a terminal of the type described in Japanese Patent Application Laid-Open No. 2002-184508, in which a center axis of the tab is not aligned with that of the box part, is hardly applicable to a waterproof connector of the type described in Japanese Patent Application Laid-Open No. H07-057815.

### SUMMARY OF THE INVENTION

It is therefore an objective of the present invention to solve the above problem and to provide a high quality waterproof connector even if the waterproof connector is a connector of the type, in which a center axis of the tab of the terminal is not aligned with a center axis of the box part of the terminal.

In order to attain the above objective, the present invention is to provide a waterproof connector including:

a terminal having an electric wire;

a housing body having a terminal insertion opening for inserting the terminal and a terminal receiving chamber for receiving the terminal;

a waterproofing means having an electric wire insertion hole that is approximately coaxial with the terminal insertion opening of the housing body; and

a rear holder which holds the waterproofing means and has a guide tube for guiding the terminal that is to be inserted into the terminal insertion opening, wherein a tapered part is formed in the proximity of an inlet of the guide tube, the tapered part leading an end part of the terminal inserted in the guide tube to the electric wire insertion hole of the waterproofing means on a condition that the end part of the terminal is inclined.

Preferably, the terminal includes: a bar-shaped tab for connecting the terminal to a female terminal in a mating connector by being inserted in the female terminal in the mating connector; and a box part situated on an electric wire fixing side of the tab, the tab being, situated at an end part of the terminal in an insertion direction of the terminal into the housing body, wherein a center axis of the tab is out of alignment with a center axis of a section of the box part.

According to a waterproof connector of the present invention, even if the waterproof connector is a connector of the type, in which a center axis of the tab of the terminal is not aligned with a center axis of the box part of the terminal, that is, even if the terminal used in the waterproof connector is of the type in which an end of the terminal is out of alignment with a center axis of the largest section of the terminal, the section being perpendicular to the insertion direction of the terminal into the housing body, a waterproof connector free from insecurity in terms of waterproof capability can be provided.

### BRIEF DESCRIPTION OF THE DRAWINGS

FIG. 1A is a cross sectional view illustrating a connector housing A1 constituting a waterproof connector (i.e. female connector) A according to the present invention;

FIG. 1B is a perspective view of a terminal 1 (constituting the waterproof connector A according to the present invention together with the connector housing A1), which is used by being connected to an electric wire;

FIG. 2A is an enlarged cross sectional view around a one-piece rubber plug 4 of the connector housing A1;

FIG. 2B is a side view of a terminal 1 connected to an electric wire 1d;

FIG. 3 is a cross sectional view illustrating an intermediate state when the terminal 1 having an electric wire is being inserted into a terminal insertion opening 2a of the connector housing A1;

FIG. 4 is a view illustrating a state when a size of a tapered part 3c is excessively large;

FIG. 5 is a cross sectional view illustrating a state when the terminal 1 having an electric wire is received in the terminal insertion opening 2a of the connector housing A1; and

FIG. 6 is a partially enlarged cross sectional view illustrating an intermediate state when a terminal having an electric wire is being inserted into a connector housing of a conventional female connector and a problem of such a conventional female connector.

### DESCRIPTION OF THE PREFERRED EMBODIMENTS

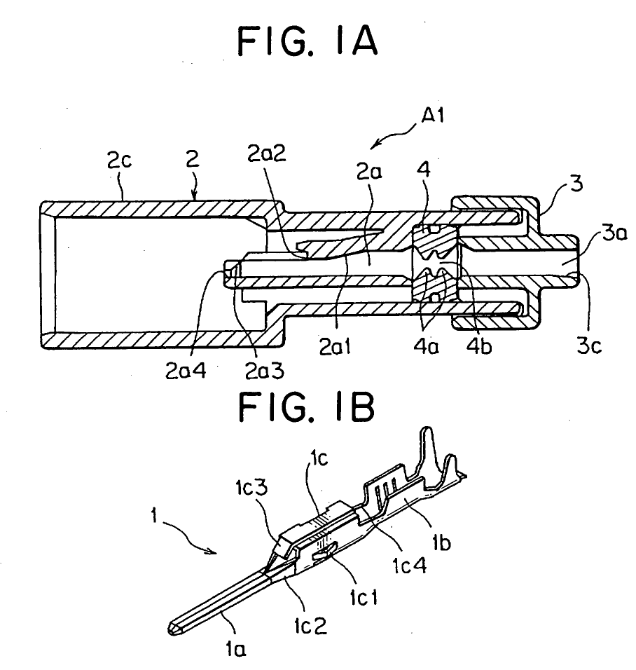

In the following, the preferred embodiments of the present invention will be explained with reference to the attached drawings. FIG. 1A is a cross sectional view illustrating a connector housing A1 constituting a waterproof connector (i.e. female connector) A according to the present invention. FIG. 1B is a perspective view of a terminal 1 which is used by being connected to an electric wire.

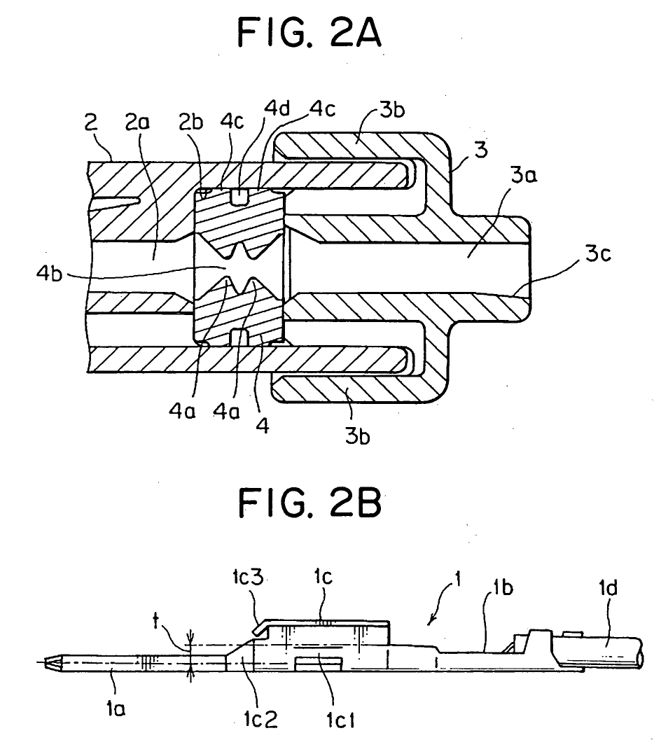

FIG. 2A is an enlarged cross sectional view around a one-piece rubber plug 4 which is a waterproofing means of the connector housing A1. FIG. 2B is a side view of a terminal 1 which is connected to an electric wire 1d.

The female connector A includes the connector housing A1 and the terminal 1 to be inserted into the connector housing A1.

The connector housing A1 includes a housing body 2, waterproofing means 4, and rear holder 3 as its primary components.

The housing body 2 has a terminal insertion opening 2a for inserting the terminal 1 having an electric wire and receives the terminal 1 inserted through the terminal insertion opening 2a.

The waterproofing means 4 is made of a soft material such as an elastomer, e.g. rubber to waterproof the circumference of the electric wire 1d and includes an electric wire insertion hole 4b which is coaxial or approximately coaxial with a center axis of the terminal insertion opening 2a of the housing body 2. In this example, a one-piece rubber plug 4 made of rubber is used.

The rear holder 3 holds the one-piece rubber plug 4 and has a guide tube 3a for guiding the terminal 1 with an electric wire, which terminal 1 is to be inserted into the terminal insertion opening 2a.

The terminal 1 includes: a bar-shaped tab 1a for connecting the terminal 1 to a female terminal in a mating connector (not shown in the figure) by being inserted in the female terminal in the mating connector when the waterproof connector A is coupled with the mating connector, the tab 1a being situated at an end of the terminal 1 in an insertion direction of the terminal 1 into the connector housing A1; an electric wire connecting part 1b for connecting the terminal 1 to the electric wire 1d; and a box part 1c situated between the tab 1a and the electric wire connecting part 1b, wherein a center axis of the tab 1a is not aligned with the center axis of the box part 1c, that is, the center axis of the tab 1a is out of alignment with the center axis of the box part 1c. As shown in FIG. 2B, there is a distance t between the two center axes.

As shown in FIG. 2A, the one-piece rubber plug 4 is held by the rear holder 3 having the guide tube 3a at a predetermined position in a receiving part 2b for receiving the one-piece rubber plug 4 in the housing body 2. The rear holder 3 includes a hood part 3b for covering the terminal insertion side-end of the housing body 2 and is fixed to the housing body 2 by a locking means (not shown in the figure).

A tapered part 3c is formed in the proximity of an inlet of the guide tube 3a, wherein the tapered part 3c leads an end part of the terminal 1 inserted in the guide tube 3a to the electric wire insertion hole 4b of the one-piece rubber plug 4 on a condition that the center axis of the tab 1a is inclined to an insertion direction of the terminal 1.

An outer circumference (outer side surface) of the one-piece rubber plug 4 is provided with: two outer lips 4c each pressure-contacting with an inner wall of the tube-shaped receiving part 2b formed on the terminal-insertion side of the terminal insertion opening 2a of the housing body 2 in a watertight manner; and a groove part 4d formed between the two outer lips 4c. The outer lips 4c and the groove part 4d improve a sliding characteristic when the one-piece rubber plug 4 is slidingly set to a predetermined position (shown in the figure) of the receiving part 2b, enabling an easy setting to the predetermined position. Also, after the setting, a high watertight property is attained between the inner wall of the receiving part 2b and the one-piece rubber plug 4.

The electric wire insertion hole 4b communicates with the terminal insertion opening 2a and the guide tube 3a.

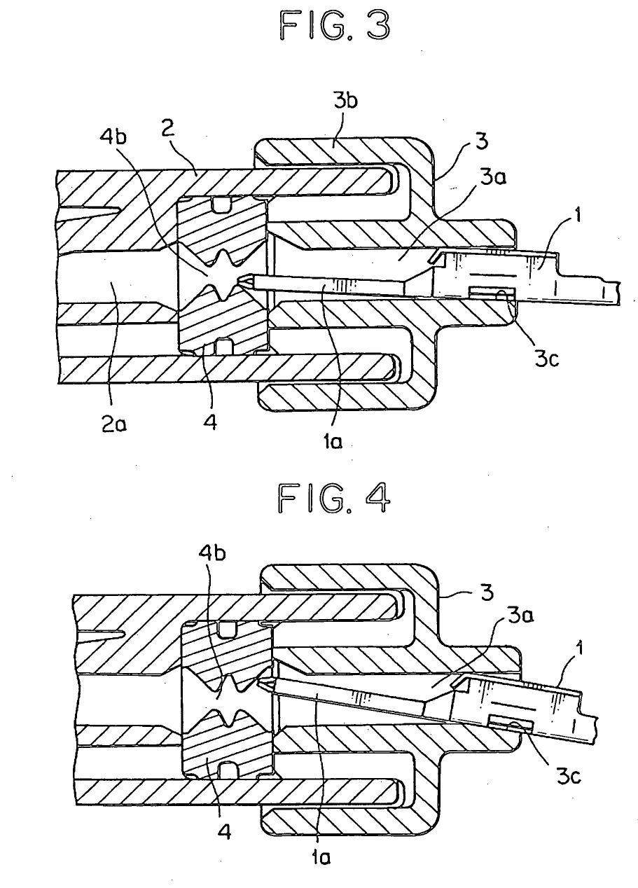

FIG. 3 illustrates an intermediate state when the terminal 1 having an electric wire is being inserted into a terminal insertion opening 2a from the guide tube 3a of the connector housing A1.

FIG. 3 illustrates a state when an end part of the tab 1a of the terminal 1 enters in the electric wire insertion hole 4b.

At a stage shown in FIG. 3, the terminal 1 can freely move in a range permitted by the tapered part 3c formed in the proximity of the inlet of the guide tube 3a.

The terminal 1 is moved in a direction of the coupling of the two connectors (i.e. the waterproof connector A and the mating connector) in the guide tube 3a by hold and guide of the electric wire 1d. The end part of the tab 1a of the terminal 1 abuts against a side surface of the one-piece rubber plug 4 on a condition that the tab 1a of the terminal 1 is inclined. The side surface of the one-piece rubber plug 4 is provided with electric wire insertion lips 4a toward the electric wire insertion hole 4b. Therefore, the end part of the tab 1a of the terminal 1 is guided into the electric wire insertion hole 4b with the aid of the tapered part 3c while the terminal 1 advances in the insertion direction of the terminal 1.

When the terminal 1 is being inserted, the insertion work is carried out by moving a holding part of the electric wire downward in the figure, so that the end part of the tab 1a can be guided into the electric wire insertion hole 4b without guidance for the end part of the tab 1a by the side surface of the one-piece rubber plug 4.

Thus, the end part of the tab 1a is guided into the electric wire insertion hole 4b of the one-piece rubber plug 4 by the tapered part 3c, therefore the end part of the tab 1a never abuts against the one-piece rubber plug 4 with a perpendicular angle or an approximately perpendicular angle. As a result, occurrence of damage of the one-piece rubber plug 4 near the electric wire insertion hole 4b due to friction with the end part of the tab 1a is prevented in advance.

A size of the tapered part 3c must be such that the end part of the tab 1a inserted in the guide tube 3a is guided into the electric wire insertion hole 4b on a condition that the tab 1a is inclined. If the size of the tapered part 3c is excessively large, as shown in FIG. 4, the end part of the tab 1a strays off the electric wire insertion hole 4b and abuts against a portion of the one-piece rubber plug 4 with a large angle, causing a damage for that portion. Therefore, a size of the tapered part 3c must be adjust to be a suitable size.

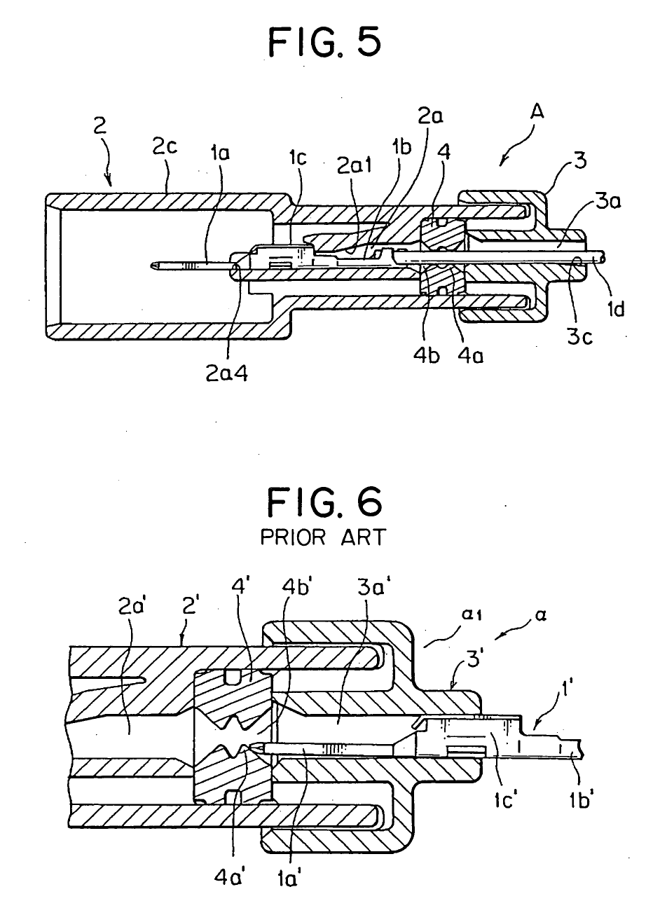

FIG. 5 illustrates a state when the terminal 1 having an electric wire is received and held in a terminal receiving space in the connector housing A1.

When the terminal 1 having an electric wire is received in the terminal receiving space, the two electric wire insertion lips 4a formed on the inner side surface of the electric wire insertion hole 4b pressure-contact with the circumference of the electric wire 1d, therefore a secure watertight characteristic can be attained.

In the above embodiment, an example of the waterproof connector A of the type in which one terminal is received inside is explained. However, the present invention can be applicable to a waterproof connector of the type in which a plurality of terminals (such as in a form of single column—plural ranks, plural columns—single rank, and plural columns—plural ranks) are received inside, that is, the present invention includes such a waterproof connector as well.

The aforementioned preferred embodiments are described to aid in understanding the present invention and variations may be made by one skilled in the art without departing from the spirit and scope of the present invention.

What is claimed is:

1. A waterproof connector comprising:
a terminal having an electric wire;
a housing body having a terminal insertion opening for inserting the terminal and a terminal receiving chamber for receiving the terminal;
a waterproofing means having an electric wire insertion hole that is approximately coaxial with the terminal insertion opening of the housing body; and
a rear holder which holds the waterproofing means and has a guide tube for guiding the terminal that is to be inserted into the terminal insertion opening, wherein a tapered part is formed in the proximity of an inlet of the guide tube, the tapered part leading an end part of the terminal inserted in the guide tube to the electric wire insertion hole of the waterproofing means on a condition that the end part of the terminal is inclined.

2. The waterproof connector according to claim 1, wherein the terminal includes: a bar-shaped tab for connecting the terminal to a female terminal in a mating connector by being inserted in the female terminal in the mating connector; and a box part situated on an electric wire fixing side of the tab, the tab being situated at an end part of the terminal in an insertion direction of the terminal into the housing body, wherein a center axis of the tab is out of alignment with a center axis of a section of the box part.
